(19) United States
(12) Patent Application Publication
(10) Pub. No.: US 2005/0027700 A1
(43) Pub. Date: Feb. 3, 2005

(54) Content delivery method and apparatus

(76) Inventors: Jeffrey Lynn Turner, Pleasanton, CA (US); Rodman Stuhlmuller, San Jose, CA (US); John Lee, Ashland, OR (US); Andrew MacBride, Moraga, CA (US)

Correspondence Address: Law Office Of Leland Wiesner, 366 Cambridge Ave., Palo Alto, CA, 94306, US

(21) Appl. No.: 10/836,572

(22) Filed: May 1, 2004

Related U.S. Application Data
(60) Provisional application No. 60/467,741, filed on May 2, 2003.

(51) Int. Cl. G06F 7/00

(52) U.S. Cl. 707/3

(57) ABSTRACT

A method and system for delivering digital content over a network includes receiving a request for content from a computer-based content ordering device according to a criteria specified through a user interface associated with the computer-based content ordering device, determining if at least one or more content providers have the requested content stored on one or more computer content storage devices and capable of delivering the content in accordance with the criteria specified on the computer-based content ordering device, presenting offers to provide content on the computer-based content ordering device from the one or more content providers matching the criteria, receiving authorization from the computer-based content ordering device directing one of the one or more content providers matching the criteria to provide the content as requested and delivering the content from the authorized content provider to a content delivery destination specified by the computer-based content ordering device.

### CROSS-REFERNCE TO RELATED APPLICATIONS

This application claims priority to U.S. Provisional Application Ser. No. 60/467741 of Interstream, LLC filed May 1, 2003 entitled Content Delivery Method and Apparatus which is incorporated herein by reference.

### BACKGROUND OF THE INVENTION

The present invention relates to networking and delivering content over a network. The increasing availability of broadband services and the relatively inexpensive cost has made it possible for people to share content freely. Often content is being shared over broadband with disregard to ownership rights in the copyright or other material being distributed. Many have implemented peer-to-peer content sharing systems that run almost autonomously and are very difficult to shut down or control. As a result, software piracy has run rampant with the combination of peer-to-peer computing and broadband availability.

Alternative online distributors of content and video movies are also available but also not desirable. Even with a broadband connection, many movies would take many hours to stream due to their size and resolution. While these broadband connections could be improved to download entire material more rapidly, this is also not the solution. Even with digital rights management (DRM) technology, it is not practical to download a complete movie and difficult for content owners to control sharing.

Conventional content delivery work by lowering the quality and resolution of content delivered. Video and other content are sent at lower resolution as the bandwidth infrastructure can not be relied upon to deliver larger amounts of data in a streaming or other format. Instead, content delivered over the Internet must rely upon a “best efforts” model for providing bandwidth. No guaranteed delivery exists on the Internet even though people would like to receive higher quality digital content and are willing to pay a premium for such services.

What is needed is a system that ensures high quality content delivered through the Internet and other networks.

### BRIEF DESCRIPTION OF THE DRAWINGS

FIG. 1 is a block diagram overview of a content delivery network designed in accordance with one implementation of the present invention;

FIG. 2 is a flowchart diagram of the operations associated with delivering digital content over a network in accordance with one implementation of the present invention;

FIG. 3 is a flowchart diagram of the operations for paying for digital content delivered over a network in accordance with one implementation of the present invention;

FIG. 4 is a schematic diagram of a content delivery network using multiple escrow network devices to transmit content and payment in accordance with one implementation of the present invention;

FIG. 5 is a flowchart diagram illustrating the operations for creating a content delivery network in accordance with one implementation of the present invention; and

FIG. 6 is a block diagram of a system used in one implementation for performing the apparatus or methods of the present invention.

Like reference numbers and designations in the various drawings indicate like elements.

### SUMMARY OF THE INVENTION

One aspect of the present invention features a method and system for delivering digital content over a network, including receiving a request for content from a computer-based content ordering device according to a criteria specified through a user interface associated with the computer-based content ordering device, determining if at least one or more content providers have the requested content stored on one or more computer content storage devices and capable of delivering the content in accordance with the criteria specified on the computer-based content ordering device, presenting offers to provide content on the computer-based content ordering device from the one or more content providers matching the criteria, receiving authorization from the computer-based content ordering device directing one of the one or more content providers matching the criteria to provide the content as requested and delivering the content from the authorized content provider to a content delivery destination specified by the computer-based content ordering device.

### DETAILED DESCRIPTION

Aspects of the present invention are advantageous in at least one or more of the following ways. A content delivery network provides infrastructure for a wider range of content providers to deliver content to more potential subscribers. By opting into the terms and conditions for delivering content, the content provider is able to leverage infrastructure and relationships already in place on the content delivery network. Escrow network devices in the content delivery network ensure payment to the content provider upon successful delivery of content to a subscriber member. The content provider is able to make premium-fees for delivering high-quality premium content without the capital expenditure associated with building a premium network.

Subscribers also benefit from the content delivery network as they are able to receive content from a wider range of sources. Instead of subscribing to single content source, the subscriber can receive the benefits of accessing multiple content providers participating in a content delivery association. The subscriber becomes part of the content delivery association to gain access to a wider range of content and pay for specific content at competitive prices. Not only does the subscriber have the ability to determine the content being delivered but has the ability to demand a certain level of quality for delivering the content. Once again, escrow network devices condition payment of fees from the subscriber upon premium delivery of content and not simply continuous monthly access to the content. If multiple sources for content exist, the subscriber can also select the lowest cost provider of the desired content as the content providers will able to compete for delivering content at different price points.

Yet another benefit is for the network infrastructure and parties managing the infrastructure of the content delivery network. Additional participants in the content delivery association include account providers, network service providers, broadband providers and others involved with the transport of content between the content providers and the subscribers. These additional participants in the content delivery association are motivated to keep the content delivery network providing content at premium delivery rates with low-frame loss, low-packet loss and low-latency. Lower downtimes and higher continuous throughput of the content delivery network results in greater profits for the additional participants. Escrow network devices sitting at peering exchanges and other core points in the network monitor performance and control payment to these various additional participants as part of each content delivery transaction.

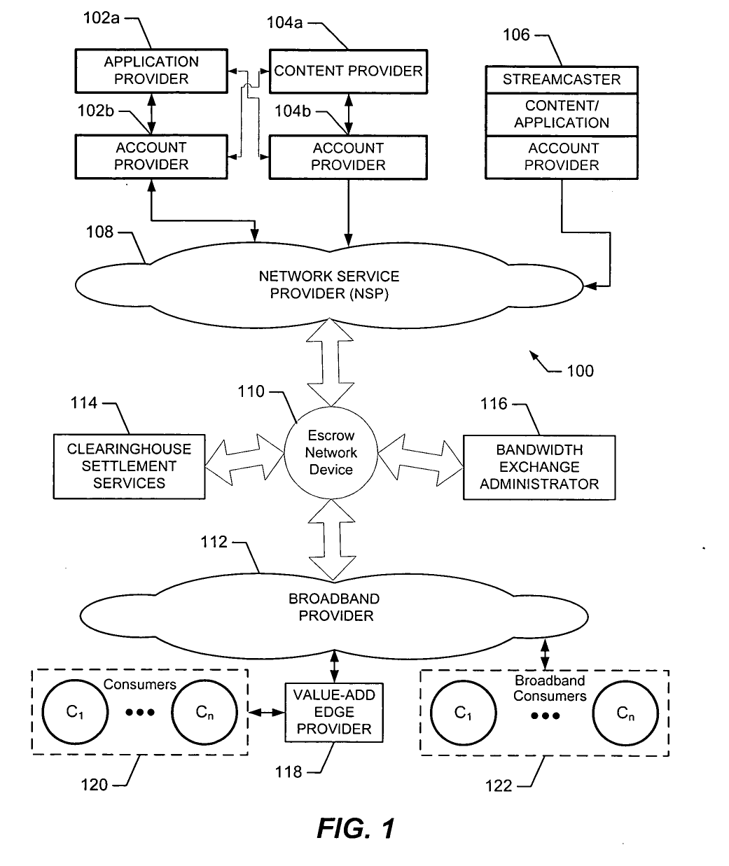

FIG. 1 is a block diagram overview of a content delivery network designed in accordance with one implementation of the present invention. Content delivery network 100 includes an application provider 102a, a content provider 104 and a streamcaster 106 providing content and/or applications to subscribers of the content delivery network 100 through network service provider (NSP) 108.

Application provider 102a provides applications to subscribers through an application service provider (ASP) or other model using content delivery network 100 to deliver applications. These applications are a special type of content that includes utility type applications (i.e., word processing, spreadsheet, graphics and presentations) as well as interactive multi-user or single user gaming applications allowing many people to play games taking advantage of the low-latency and high-throughput capabilities of content delivery network 100. In one implementation, application provider 102a uses account provider 102b to maintain ongoing subscriptions with subscribers on content delivery network 100. Alternatively, application provider 102a may decide to use account provider 104b to manage these subscriber business relationships as these account provider businesses typically operate as distinct business entities within content delivery network 100.

Content provider 104a delivers a broader range of content over content delivery network 100. Generally, content provider 104a delivers digitized voice, images, video, text and other data over content delivery network 100. Like application provider 102a, content provider 104a may rely on either account provider 102b, account provider 104b or any other account provider participating in content delivery network 100. This allows content provider 104a to focus on delivering premium content to subscribers of content delivery network 100 rather than the business logistics of maintaining subscriber accounts and day-to-day business relationships.

Streamcaster 106 is yet another type of content provider participant in content delivery network 100. Certain larger content providers may find it more cost-effective to combine the functions of the content provider and the account provider in a single business entity. Like a broadcaster in television and radio, Streamcaster 106 either owns or manages content and also manages and works with subscribers through integrated account provider services within their own organization. Despite the size and added internal functions, streamcaster 106 must abide by the same criteria imposed on content provider 104a and application provider 102a to participate in the content deliver network 100 and delivery content to subscribers.

Content passing through a network service provider 108 is consolidated at a escrow network device 110 located at strategic points on the network likely to encounter significant amounts of traffic enroute to subscribers of content delivery network 100. For example, escrow network device 100 can be located at peering exchanges where multiple network service provider 108 come together.

Network service provider 108 typically provides networking bandwidth operating at higher-rates and reliability as it moves data through a backbone of connectivity within the Internet, an extranet, an intranet, an extranet and even a private network. These portions of a network are sometimes referred to as transit areas of the network as the bandwidth are purchased and used in bulk amounts. In some cases, the transit network portions of the network not only cover a single country or continent but span several countries and/or continents.

Escrow network device 110 steps a portion of this traffic down to subscribers through one or more different broadband provider 112. Consumers 120 and broadband consumers 122 then subscribe and receive content in content delivery network 100 through value-add edge provider 118 or directly through broadband provider 112 respectively. For example, consumers 120 and broadband consumers 122 typically access content delivery network 100 through various public networks, satellite networks, cable-based distribution networks, copper/telephone-based networks (i.e., digital subscriber line—DSL technology) as well as various types of wireless networks. Broadband provider 112, value-add edge provider 118 and other types of network providers are participants in content delivery network 100 and also receive monetary remuneration for keeping up with their portion of the delivery criteria established in content delivery network 100. Details on the payments to broadband provider 112 and edge provider 118 as well as the role of escrow network device 110 are described in further detail later herein.

Clearinghouse settlement services 114 settles and disburses money and money equivalents deposited with escrow network device 110. With each completed transaction and delivery of content, clearinghouse settlement services 114 compares the criteria for delivering the content with the performance metrics collected on the actual delivery. A participating member of content delivery network 100 that performs their role and maintains the required criteria collects the promised payment amount held in one or more of escrow network device 110.

In one implementation, clearinghouse settlement services 114 directs escrow network device 110 to securely and rapidly transfer funds and/or equivalents into a deposit account associated with various participants in content delivery network 100. For example, a deposit can be made in a transit provider associated NSP 108 for maintaining proper uptime of the network. However, in the same transaction a wireless-hot spot value-add edge provider 118 in the same aforementioned transaction may receive little or no pay when the wireless-hot spot network became inaccessible in the middle of a transaction and renders the requested content inaccessible.

A bandwidth exchange administrator 116 monitors and reports on the performance associated with the delivery of content passing through escrow network device 110. It is the role of bandwidth exchange administrator 116 to monitor transactions and activities taking place throughout content delivery network 100 and ensure content is being delivered at the premium or other levels requested or required. To maintain objectivity, bandwidth exchange administrator 116 is a physically and logically separate entity from other participants in content delivery network 100. In one implementation, bandwidth exchange administrator 116 is paid a fee commensurate with increasing the amount of content being delivered over content delivery network 100. This would encourage bandwidth exchange administrator 116 to carefully monitor performance metrics on escrow network device 110 and ensure participants carefully abide by the delivery and other criteria on the content delivery network. Alternatively, bandwidth exchange administrator 116 attaches a relatively small fee per transaction for successfully auditing the transaction and generating timely metrics for use by clearinghouse settlement services 114 and other constituents of content delivery network 100.

It is worth noting that each participant or member of content delivery network 100 has different criteria for operating and receiving payment. These criteria vary depending on the role of the participant in the particular transaction or delivery of content and the features of the transaction. For example, content provider 104a can have criteria for delivering high-quality video, audio or images with high resolution, audio quality and/or vibrant colors as appropriate. In addition, content provider 104a can also have criteria related to providing content at price points considered competitive and thus popular. Network service provider (NSP) 108 would have different criteria in content delivery network 100 related to keeping transit traffic moving quickly with low-latency and little downtime. Subscribers like consumers 120 or broadband consumers 122 would have criteria to make timely payments for content they purchase either through credit cards, bank debits or cash equivalents.

For example, a subscriber could submit to viewing more commercials or adverts in the delivered content in exchange for a pro rata lowering of overall costs for delivering content and applications. If it is available, a subscriber may even be allowed to receive some or all content for very little actual money in exchange for allowing bandwidth exchange administrator 116 to collect additional data on transactions and include the data collected on the subscriber in sophisticated and valuable marketing and demographic research. The different criteria for each of the participants of content delivery network 100 can be determined in advance or negotiated dynamically for each transaction or each delivery of content depending on the efficacy of doing so on the overall delivery process.

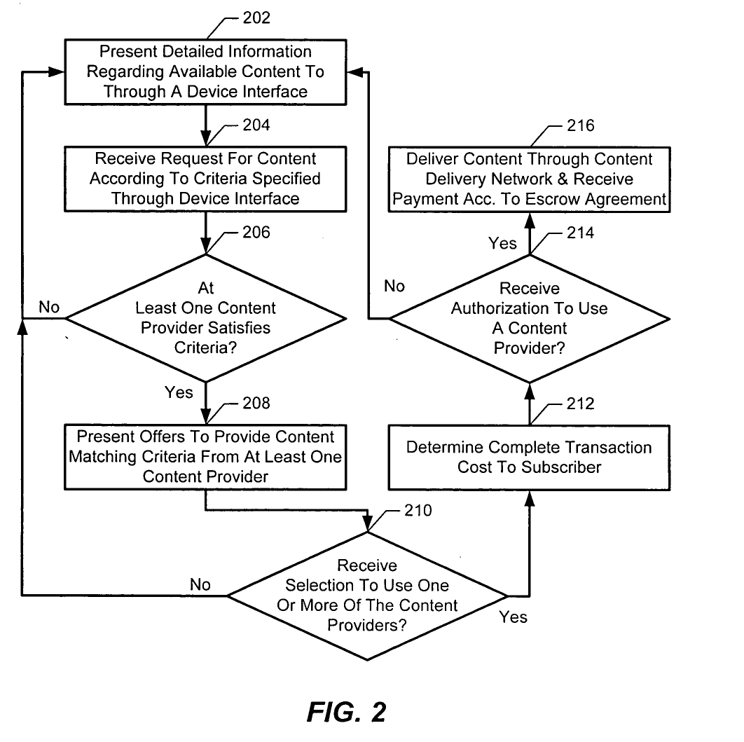

FIG. 2 is a flowchart diagram of the operations associated with delivering digital content over a network in accordance with one implementation of the present invention. A subscriber generally orders content interactively using a computer-based ordering device. The computer-based ordering device can be a combination of one or more different computer and multimedia capable technologies. For example, the computer-based ordering device can be a set-top box device operatively coupled to a display device and one or more human interface devices capable of receiving input from a user, a personal computer operatively coupled to a display device and one or more human interface devices, a personal digital assistant, a wireless phone with display and one or more human interface devices, a television having an integrated storage device and processor for storing content also having one or more human interface devices. These human interface devices to be used in conjunction with computer-based ordering device include: a keyboard, a mouse, a touch-pad, a wireless remote, a voice-activated interface, a thumb-key pad, a touch-screen, a gesture-based interface and a pen-based interface. In one implementation, the subscriber uses a wireless keyboard and mouse to communicate information to a set-top box connected to a television set. An alternative and more sophisticated implementation would utilize a personal digital assistant accessing a web page associated with a remotely located set-top box associated with a subscriber's television at home or the office. The web page would provide an interface to the content delivery network and allow the subscriber to order and obtain content.

In any one of the above or other configurations, the computer-based ordering device (hereinafter ‘the device’) presents detailed information regarding available content to the subscriber (202). Detailed information regarding available content includes criteria related to describing and searching for desired content. The subscriber selects different content criteria to find interesting or desired content or material from content providers on the content delivery network. In one implementation, the content related criteria is part of an interface and includes content related selections including: a title, a genre, an interest area, an activity, people, audio options, video options, a community, an age range, ratings, geography and language. If a specific title or content is not selected, the subscriber can specify differently weighted or ranked combinations of various categories and search for content fitting the combined request. Of course, these are only illustrative examples of possible selections presented on the device to the subscriber and many other possible selections and combinations thereof are also possible. It is also worth noting that the subscriber can interactively select individual delivery of content or can setup preferences to have the content delivery network continuously send content and information meeting the content criteria selections made.

Responsive to the subscriber's selections, the content delivery network receives a request for content according to criteria specified through the device interface (204). The request is then distributed of to one or more content providers and members of a content delivery association affiliated with the content delivery network. The content delivery association includes content providers and other members of the content delivery network that cooperate together to provide content for a fee on a demand basis to subscribing members. Membership to the content delivery association can be fee based or based upon continued performance to standards setup and managed by the content delivery association members and board.

In one implementation, the content delivery association includes an independent audit organization that audits delivery of content by the one or more content providers to the subscribing members of the content delivery network. For example, this audit function could be performed by the bandwidth exchange administrator 116 previously illustrated and described in conjunction with FIG. 1. Auditing functions built into an escrow network device designed in accordance with the present invention would perform packet inspection operations and transmit performance metrics to the bandwidth exchange administrator 116 or other party responsible for auditing delivery transactions.

Performance metrics could be derived from a set of content delivery criteria established and agreed upon by members of the content delivery association in their by-laws or established more specifically by each subscriber through the interface on the computer-based content ordering device. These content delivery criteria could apply to all the subscriber's request for content or subject to modification for each different request; it would be used in addition to a set of content criteria for requesting actual content from the various content providers. For example, the delivery criteria could include specifying threshold delivery requirements including: a minimum frames-per-time-unit, a maximum frame-loss per time-unit, a payment range, a video format and/or quality of resolution, a maximum packet loss, limited jitter, an audio format and/or quality of aural reproduction.

In addition, the content delivery association may also include another independent organization that escrows fees, monitors the exchange of content and pays fees to the content providers and others in the content delivery path delivering in accordance with predetermined delivery criteria. This function could be performed by clearinghouse settlement services 114 as illustrated and described in FIG. 1 or any other third party designated by the content delivery association. In general, both of the previously described functions and organization (i.e., the audit function and the escrow function) could be performed using equipment and members associated with the content delivery association that operated independently and objectively or be independent objective third-parties outside the content delivery organization.

In light of the subscriber's request, the content delivery network determines if at least one member of the content delivery network has content that meets the specified criteria (206). The content subscriber is notified if no content provider in the content delivery network is able to provide the content meeting the requisite criteria. For example, the content provider may be unable to provide content if they do not carry the specific title or even if they have the title but cannot deliver the content at a specified bandwidth or quality.

In the event multiple content providers match the criteria of the subscriber's request, these content providers present offers to provide the content and the corresponding terms and conditions (208). Each different offer to provide the content meets the subscriber's criteria but may differ in price or other factors not considered or limited in the request. For example, one content provider may provide the same or similar content for a different price point due to different licensing or royalty arrangements they have with the content owner while another content provider may have subtitles, special enhanced colorization or other unusual features to justify a higher or different price point from the other content providers. Certain content providers may also have lower costs decide in a certain genre of content or have lower communication or network costs within the content delivery network due to their geographic proximity to the subscriber making the request or requests.

A subscriber can reject all offers or select one or more content provider to provide the requested content (210). For example, the subscriber may want to add or remove criteria to affect the number of content providers making offers to provide the requested content. Before authorizing delivery, the one or more content providers are responsible for determining a complete transaction cost to the subscriber (212). In one implementation, the complete transaction cost may include one or more fees associated with one or more aspects of the transaction including: ownership rights to content, royalties, utilizing bandwidth to deliver the content, access to communications equipment, membership fees in the content delivery association, taxes and tariffs. These costs are predictable and lower in nature as the services and fees emanate from other members of the content delivery association/content delivery network and are negotiated in advance. For example, members of the content delivery association provide negotiated rates to each other in advance for their services on a per transaction basis and receive payment upon fulfilling their roles in accordance with the specified criteria and escrow agreement.

Once again, a subscriber can either reject the offers from the content provider or the content delivery network receives the subscriber's authorization to use a content provider (214). This content provider then delivers content through content delivery network and receives payment according to the escrow agreement (216). In one implementation, the authorization also requires the subscriber to directly or indirectly submit a fee for the content into an escrow account to be paid to the content provider and one or more other members of the content delivery association consistent with the complete transaction cost. In practice, the content provider or account holder may use their own funds already being escrowed by the escrow network device and collect from the subscriber through a credit card or other financial relationship. Actual deliver delivery of content typically occurs in accordance with the criteria specified through the computer-based content ordering device. For example, the subscriber can specify the content delivery destination for delivery as a set-top box in proximity of the computer-based content ordering device, a set-top box remotely located to the computer-based content ordering device, a network attached storage device or a computer having sufficient direct storage or network available storage to store the content. Further details on receiving the escrowed payment in exchange for delivery of the content are described in further detail later herein.

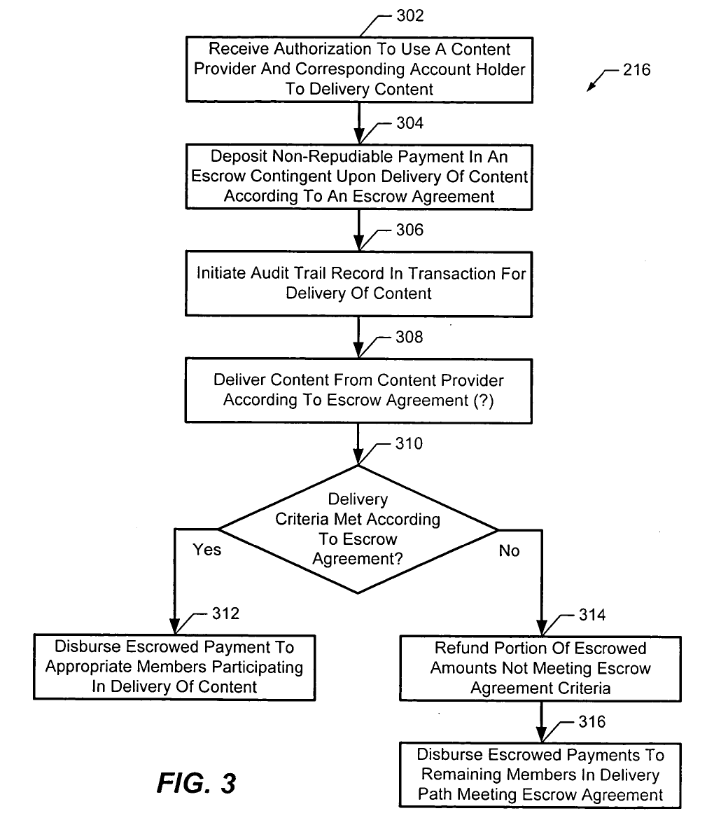

FIG. 3 is a flowchart diagram of the operations for paying for digital content delivered over a network in accordance with one implementation of the present invention. Initially, a content provider, a account holder and others in the content delivery association receive authorization from a subscriber to deliver requested content (302). The subscriber agrees to pay the content provider and account holder the specified payment upon delivery and specifies the destination location for the content. In one implementation, the authorization is provided interactively by a subscriber operating a computer-based content ordering device. Alternatively, authorization for payment is provided in advance through a service agreement with the content provider or account holder to provide content over an interval of time.

Accordingly, the subscriber deposits a non-repudiable payment in an escrow contingent upon delivery of content according to an escrow agreement (304). As previously described, the subscriber can deposit funds directly or indirectly into escrow. In some cases, the subscriber does not deposit funds directly but relies on the account provider to deposit the funds until the delivery and transaction is complete. To ensure payment is secure, payment is made in the form of a non-repudiable digital bearer certificate stored on the escrow network device to ensure payment for content if delivered according to the criteria in the escrow agreement. Digital bearer certificates provide the current holder or ‘bearer’ of the certificate the right to a certain amount of money without the significant overhead and complexity of endorsements.

The inability to repudiate the funds helps keep the subscriber from canceling the transaction midstream as they would lose their funds and also not receive the requested content. For the subscriber, the escrow of payment performed by the escrow network device also ensures the subscriber will not pay for content unless it is delivered as required. These and other benefits of escrow in accordance with the present invention are made available to subscribers, content providers and other admitted members of the content delivery association.

This non-repudiability of funds also helps prevent unauthorized access to the content delivery network and attempts to crack into the escrow switch device. For example, a denial of service (DoS) occurs when various attacks are made concurrently on a particular system on the Internet. Even if an unauthorized party could access the escrow network device, the party attempting to access the escrow network device without authorization would eventually have to also deposit non-repudiable funds to gain access. Creating an escrow system for content requires a party to submit non-repudiable payment prior to initiating a stream of data into the system or demanding content from the system. This financial disincentive is likely to ward off parties from attempting to gain access to the content delivery network without authorization.

Implementations of the present invention initiate an audit trail record for the transaction to monitor delivery of the content (306). As previously described, an entity access information in the escrow network device indicating metric information concerning the delivery of content in different transactions. Auditing is an important part of the escrow as the resulting metrics are compared with the actual delivery requirements made part of the escrow agreement.

Audit information and results are used to determine if delivery criteria is met according to the escrow agreement terms and conditions (310). In one implementation, the escrow agreement includes criteria describing the request for content as well as other criteria concerning the manner in which the content is to be delivered. In general, the disbursement of payment made into escrow to content providers and others depends on audit information stored in a database describing the delivery of the content and whether the audit information matches the criteria specified in the escrow.

Each member of the content delivery network is paid or not paid depending on whether the audit information indicates they met or did not meet the specified criteria. If the content and delivery criteria are met then the escrow network device disburses escrowed payment to appropriate members participating in delivery of content (312). Alternatively, members not meeting the criteria are not paid out of escrow and the subscriber is refunded at least the portion of escrowed amounts not meeting the criteria in the escrow agreement (314). Remaining members in the delivery path meeting the escrow agreement receive their fees as the remaining amounts of the escrowed payments are disbursed (316). In an alternate implementation, members of the content delivery network are paid on a sliding scale depending on how closely they are able to meet the criteria associated with their role in delivering the requested content.

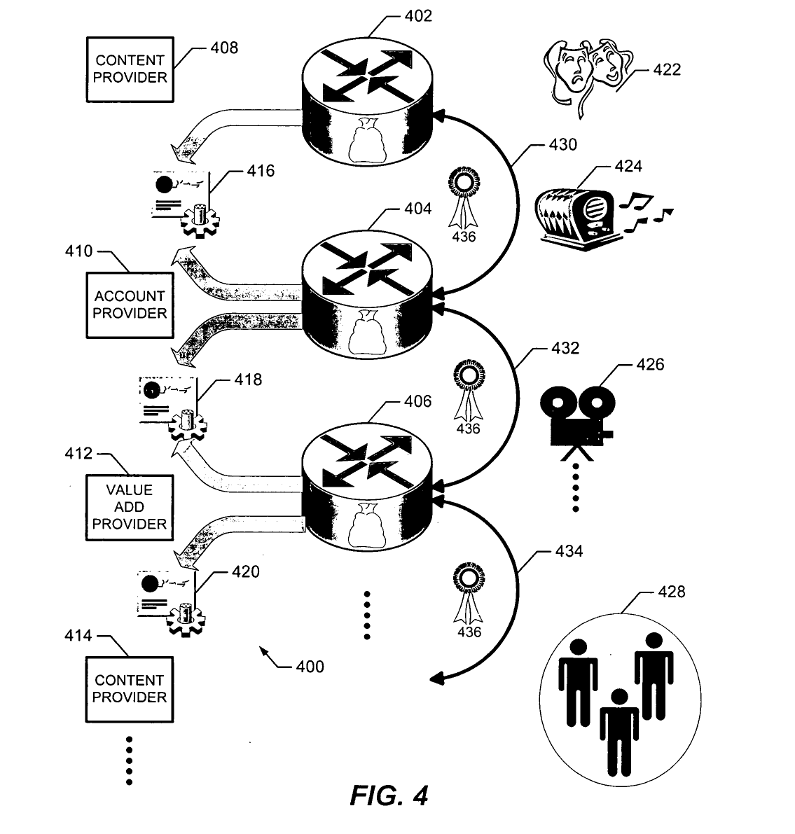

FIG. 4 is a schematic diagram of a content delivery network using multiple escrow network devices transmitting content and payment in accordance with one implementation of the present invention. This example content delivery network 400 includes escrow network device 402, escrow network device 404, escrow network device 406, content provider 408, account provider 410, value add provider 412, another content provider 414 and subscribers 428. Theatre content 422, music radio content 424, and movie content 426 are a few examples of the type of digital or digitized content delivered over content delivery network 400 using one or more escrow network devices. Digital certificates 416, 418 and 420 are used to move cash equivalents to different members of the content delivery network as content is delivered and escrows settled. Metrics 436 indicate the delivery of content is being performed at acceptable levels in view of the criteria associated with the original request for the content.

In operation, escrow network devices 402, 404 and 406 have the dual role of transmitting content to subscribers 428 and settling their payments for the content to different members on the content delivery network including content provider 408, account provider 410, value added provider 412 and content provider 414. For example, subscribers 428 request content and discover that content provider 414 is capable of providing the requested content. Content provider 414 delivers the content through one or more escrow network devices 402, 404 and 406. Meanwhile, metrics 436 are being collected to determine if the content is being delivered as specified or below the criteria for delivering content. Escrow router devices exhange digtal bearer certificates 410, 412 and 414 between each other as content is delivered and the escrow router devices 402, 404 and 406 settled transactions and disburse payments to the various members of the content delivery association and network.

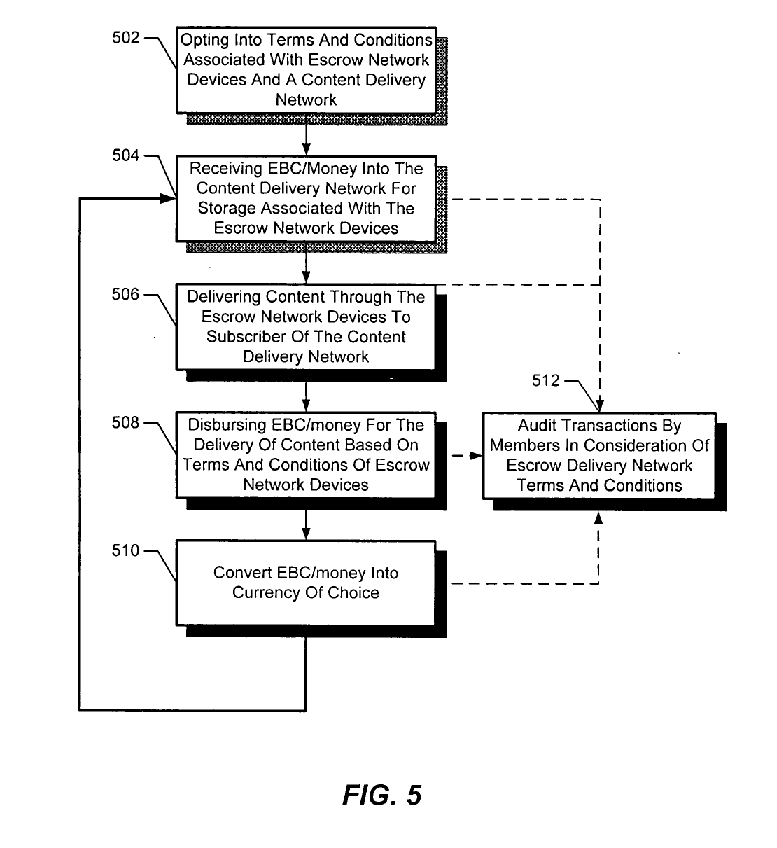

FIG. 5 is a flowchart diagram illustrating the operations for creating a content delivery network in accordance with one implementation of the present invention. In this example, the content delivery network infrastructure includes a number of escrow network devices connected together forming a network. Initially, various parties opt into terms and conditions associated with escrow network devices (502) and the content delivery network. This means that each member of the content delivery network agrees to facilitate the delivery of content under certain criteria and receive payment through settlement of an escrow when the payment for content is distributed.

The content delivery network of the present invention receives electronic bearer certificates (EBC)/Money on various nodes the content delivery network (504). The deposited money or EBC is used for temporary payment for content or storage as well as keeping the transaction delay low when the content delivery network is busy.

Once a request for content is made, implementations of the present invention deliver content through the escrow network devices and onto the subscriber members of the content delivery network (506). If the content is delivered according to the delivery or content criteria, the EBC/money is disbursed to the various members and based on the terms and conditions specified within the escrow network devices (508). A member of the content delivery network can either convert the EBC/money into a currency of choice or redeposit the money back into the system as illustrated (510). As previously described, a separate entity audits transactions by escrow members in consideration of escrow delivery network terms and conditions (512).

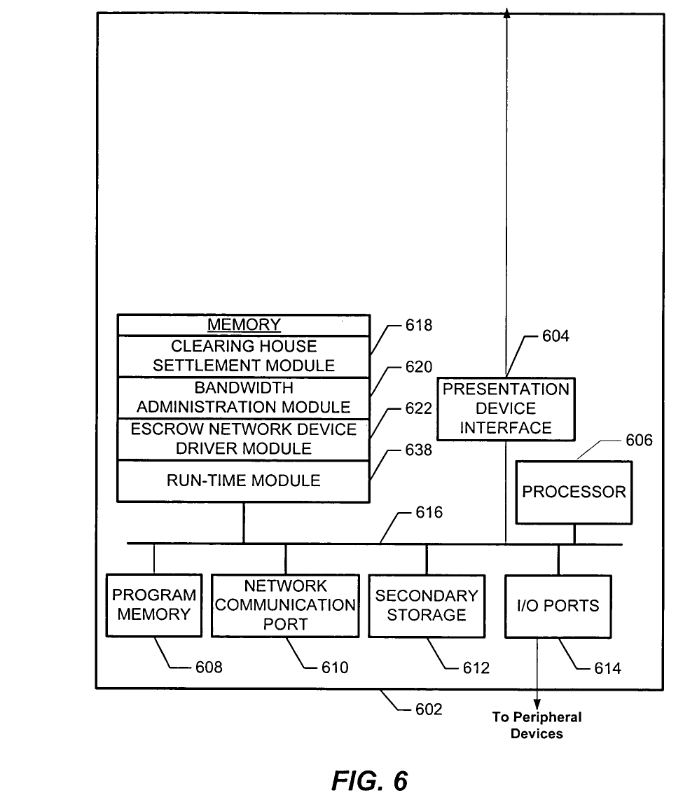

FIG. 6 is a block diagram of a system 600 used in one implementation for performing the apparatus or methods of the present invention. System 600 includes a memory 602 to hold executing programs (typically random access memory (RAM) or read-only memory (ROM) such as a flash ROM), a presentation device interface 604 capable of interfacing and driving a display or output device, a processor 606, a program memory 608 for holding drivers or other frequently used programs, a network communication port 610 for data communication, a secondary storage 612 with a secondary storage controller and input/output (I/O) ports and controller 614 operatively coupled together over interconnect 616. System 600 can be preprogrammed, in ROM, for example, using field-programmable gate array (FPGA) technology or it can be programmed (and reprogrammed) by loading a program from another source (for example, from a floppy disk, a CD-ROM, or another computer). Also, system 600 can be implemented using customized application specific integrated circuits (ASICs).

In one implementation, memory 602 includes a clearing house settlement module 618, a bandwidth exchange module 620 and a escrow network device module 622. Clearing house settlement module 618 accesses performance and metric data associated with an escrow network device and directs settlement of escrow as payment to the various members of the content delivery network deserving remuneration. Bandwidth exchange module 620 performs various operations with monitoring content in the forms of packets and connections as they pass through one or more escrow network devices. Escrow network device module 622 drives operation of escrow network devices on the content delivery network exchanging funds securely in the form of money, money equivalents, digital bearer certificates as well as content.

As illustrated, these various modules of the present invention appear in a single computer system. However, alternate implementations could also distribute these components in one or more different computers to accommodate for processing demand, scalability, high-availability and other design constraints. Similarly, . . .

While examples and implementations have been described, they should not serve to limit any aspect of the present invention. Accordingly, implementations of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

While specific embodiments have been described herein for purposes of illustration, various modifications may be made without departing from the spirit and scope of the invention. For example, content is described and mentioned several times with respect to video, audio and images however any type of date capable of being represented digitally is also included in the term content. This includes all types of gaming applications that require long term connectivity and can take advantage of the low-latency and low-packet loss made available through aspects of a content delivery network designed in accordance with the present invention. Accordingly, the invention is not limited to the above-described implementations, but instead is defined by the appended claims in light of their full scope of equivalents.

1. A method of delivering digital content over a network, comprising:
receiving a request for content from a computer-based content ordering device according to a criteria specified through a user interface associated with the computer-based content ordering device;
determining if at least one or more content providers have the requested content stored on one or more computer content storage devices and capable of delivering the content in accordance with the criteria specified on the computer-based content ordering device;
presenting offers to provide content on the computer-based content ordering device from the one or more content providers matching the criteria;
receiving authorization from the computer-based content ordering device directing one of the one or more content providers matching the criteria to provide the content as requested; and
delivering the content from the authorized content provider to a content delivery destination specified by the computer-based content ordering device.

2. The method of claim 1 wherein the computer-based content ordering device is selected from a set of computer-based content ordering devices including: a set-top box device operatively coupled to a display device and one or more human interface devices capable of receiving input from a user, a personal computer operatively coupled to a display device and one or more human interface devices, a personal digital assistant, a wireless phone with display and one or more human interface devices, a television having an integrated storage device and processor for storing content and one or more human interface devices.

3. The method of claim 1 wherein the one or more human interface devices are selected from a set of human interface devices including: a keyboard, a mouse, a touch-pad, a wireless remote, a voice-activated interface, a thumb-key pad, a touch-screen, a gesture-based interface and a pen-based interface.

4. The method of claim 1 wherein the request is received over a combination of networks selected from a set of networks including: the Internet, an intranet, an extranet, a wireless network, a private network, a public network, a satellite network, and a cable-based distribution network.

5. The method of claim 1 wherein the criteria to be specified in the user interface includes selecting one or more criterion from a set of criterion including: a title, a genre, an interest area, an activity, people, audio options, video options, a community, an age range, ratings, geography and language.

6. The method of claim of claim 1 wherein the content providers are separate business entities affiliated through a content delivery association that cooperates to provide content for a fee on a demand basis to subscribing members of the content delivery association.

7. The method of claim 6 wherein the content delivery association further includes an audit organization that audits delivery of content by the one or more content providers to the subscribing members and pays the fee contingent upon the content providers delivering in accordance with a predetermined delivery criteria.

8. The method of claim 1 wherein the criteria specifed on the computer-based content ordering device further includes threshold delivery requirements selected from a set of delivery requirements including: a minimum frames-per-time-unit, a maximum frame-loss per time-unit, a payment range, a video format, a maximum packet loss, a maximum jitter and an audio format.

9. The method of claim 1 wherein the offers to provide content further include a complete transaction cost from each of the one or more content providers associated with delivering the requested content.

10. The method of claim 9 wherein the complete transaction cost may include one or more fees associated with one or more aspects of the transaction including: ownership rights to content, royalties, utilizing bandwidth to deliver the content, access to communications equipment, membership fees for a content delivery association, taxes and tariffs.

11. The method of claim 1 wherein the receipt of authorization further includes submitting a fee for the content into an escrow account to be paid to the content provider and one or more other members of the content delivery association consistent with the complete transaction cost.

12. The method of claim 1 wherein the delivery of content further occurs in accordance with the criteria specified through the computer-based content ordering device.

13. The method of claim 1 wherein the content delivery destination is selected from a set of content delivery destinations including: a set-top box in proximity of the computer-based content ordering device, a set-top box remotely located to the computer-based content ordering device, a network attached storage device and a computer having sufficient storage to store the content.

14. A method of paying for digital content delivered over a network comprising,
receiving authorization to use a content provider and corresponding account holder to delivery content;
depositing a payment in escrow for delivery of the content contingent upon delivery of the content to a subscriber according to criteria in an escrow agreement;
delivering the content from the authorized content provider to a device capable of storage identified as a content delivery destination as specified by a subscriber;
determining if delivery of the content met criteria specified in the escrow agreement; and
disbursing the escrowed payment to appropriate members participating in the delivery of the content over the network.

15. The method of claim 14 wherein the authorization is provided interactively by a subscriber operating a computer-based content ordering device.

16. The method of claim 14 wherein the authorization is provided in advance through a service agreement to provide content over an interval of time.

17. The method of claim 14 wherein the payment is in the form of a non-repudiable digital bearer certificate associated with a escrow network device to ensure payment for content if delivered according to the criteria in the escrow agreeement.

18. The method of claim 14 wherein the escrow is associated with a content delivery association and made available to subscribers, content providers and admitted members of a content delivery association.

19. The method of claim 14 wherein the disbursement of payment made into escrow to content providers and others depends on audit information stored in a database describing the delivery of the content and whether the audit information matches the criteria specified in the escrow.

20. The method of claim 19 further comprising,
disbursing escrowed payments to the one or more members of a content delivery association with information stored in the database indicating the criteria in escrow has been met.

21. A method of creating a content delivery network, comprising:
opting into terms and conditions associated with escrow network devices in a content delivery network capable of distributing content and disbursing payments;
receiving money into the content delivery network for storage on the escrow switching devices in the form of digital bearer certificates;
delivering content through the escrow network devices to subscriber members of the content delivery network in an attempt to meet the terms and conditions associated with the escrow switching devices;
disbursing money for the delivery of content in accordance with the terms and conditions associated with the escrow switching devices.

22. The method of claims 21 wherein the money received is stored on the escrow switching devices as non-repudiable digital bearer certificates.
